(19) United States
(12) Patent Application Publication
(10) Pub. No.: US 2025/0037117 A1
(43) Pub. Date: Jan. 30, 2025

(54) KIOSK CURRENCY DISPENSING SYSTEMS AND METHODS

(71) Applicant: Integrated Payment Technologies, LLC, Sandy Springs, GA (US)

(72) Inventor: Julius Cato, Sandy Springs, GA (US)

(21) Appl. No.: 18/784,150

(22) Filed: Jul. 25, 2024

Related U.S. Application Data
(60) Provisional application No. 63/515,409, filed on Jul. 25, 2023.

(51) Int. Cl. G06Q 20/38; G07D 11/00; G07F 19/00

(52) U.S. Cl. CPC G06Q 20/381; G07D 11/0087; G07F 19/20; G07D 2207/00

(57) ABSTRACT

An embodiment of a kiosk and currency management system and method enable quick and accurate exchanges of relatively large denomination input currency for relatively small denomination output currency. For example, the systems and methods enable the exchange of input currency having a first value and first denomination for output currency having a second lower value and a second lower denomination. Such exchanges may be quick and accurate, which may be desirable for the customer and the proprietor of the establishment into which a kiosk and currency management system is placed.

### RELATED APPLICATION

This application claims priority to co-pending U.S. provisional application entitled, “Kiosk Currency Dispensing Systems and Methods,” having Ser. No. 63/515,409, filed Jul. 25, 2023, which is entirely incorporated herein by reference.

### TECHNICAL FIELD

The present disclosure is related to methods of business and, more particularly, is related to systems and methods of providing currency management.

### BACKGROUND

Participation at many entertainment venues requires the expenditure of money. At some of these venues, money is often expended in the form of small denomination cash currency, such as single ($1.00) bills. For example, small denomination currency may be required at establishments such as arcades, and preferred at establishments such as adult entertainment clubs. As another example, patrons may wish to tip a relative small amount to service personnel at a hotel, such as valets, coat check, bellman

In today's society, many individuals opt to use alternative payment methods in lieu of cash currency such as credit cards, debit cards, gift cards, electronic fund transfers, and checks. These individuals may not carry small denomination cash currency, or may carry such a small quantity of small denomination currency that their participation at certain entertainment venues or service facilities (e.g. valet parking services, hotel concierge services, etc.) is impeded.

Before patronizing an entertainment venue where small denomination currency is required, the individual may obtain currency from a bank or an automatic teller machine. The currency obtained is often large denomination currency in the form of $20, $50, or $100 dollar bills. Because these denominations may be too large to be useful at an entertainment venue, the individual may exchange the large denomination currency for small denomination currency before participating.

Exchanging large denomination currency for small denomination currency at the entertainment venue may be undesirable for both the individual and the entertainment venue. The entertainment venue may have a limited volume of small denomination currency on hand. Once this volume is depleted, the entertainment venue may be unable to complete the individuals exchange request, which may cause the individual to expend less money at the venue. Further, replenishing the volume of small denomination currency may be inconvenient for the entertainment venue. For example, replenishing the volume of currency may require visiting a bank, which may not be open. Additionally, exchanging large denomination currency for small denomination currency often requires manual counting by an employee of the entertainment venue. The time consumed exchanging currency by manual counting may inconvenience the participant and distract the employee from fulfilling her job responsibilities. Mistakes may also occur that are costly to the entertainment venue. Further, manual counting does not enable the detection of counterfeit bills.

From the above, it is apparent that a need exists for a system and method of providing and managing currency that eliminates these problems.

### BRIEF DESCRIPTION OF THE DRAWINGS

The present disclosure may be better understood with reference to the following drawings. Matching reference numerals designate corresponding parts throughout the Figures, and components in the drawings are not necessarily to scale.

FIG. 1A is a block diagram illustrating an embodiment of a kiosk and currency management system.

FIG. 1B is a block diagram illustrating an embodiment of the kiosk and currency management system of FIG. 1A, including kiosk and currency management software.

FIG. 2 is a block diagram illustrating an embodiment of a general-purpose computer system that can be used to implement various systems and methods of currency management as disclosed herein.

FIG. 3 is a block diagram of an embodiment of a system for currency management.

FIG. 4 shows an exemplary sidecar locker storage system for one non-limiting embodiment of the present disclosure.

FIGS. 5A-5B shows varying views of a tower storage locker assembly have 3×32 storage units and 3×16 storage units, respectively, in accordance with various embodiments of the present disclosure.

### DETAILED DESCRIPTION

Described below are embodiments of a kiosk and currency management system, and of methods for providing and managing currency. The systems and methods disclosed herein may enable quick and accurate exchanges of relatively large denomination input currency for relatively small denomination output currency. For example, the systems and methods enable the exchange of input currency having a first value and first denomination for output currency having a second lower value and a second lower denomination. Such exchanges may be quick and accurate, which may be desirable for the customer and the proprietor of the establishment into which a kiosk and currency management system is placed.

The systems and methods disclosed herein thus allow the proprietor and staff to focus on servicing patrons rather than making change. Also, management can stay focused on operating of the establishment instead of going to a bank to get small denomination bills. Additionally, the proprietor's operating capital is kept safe and secure, since cash can be deposited daily into the kiosk and currency management system, and the system administrator can periodically deposit funds into a business checking account for the establishment.

Such exchanges may also generate revenue, which may be desirable for the proprietor and the administrator of a kiosk and currency management system. Under the methods herein, usage data generated by the system can be used by a proprietor to manage the system.

Other systems, devices, features, and advantages of the disclosed systems and methods for providing and managing currency will be or will become apparent to one of ordinary skill in the art upon examination of the following drawings and detailed description. All such additional systems, devices, features, and advantages are intended to be included within this description and are intended to be included within the scope of the present disclosure.

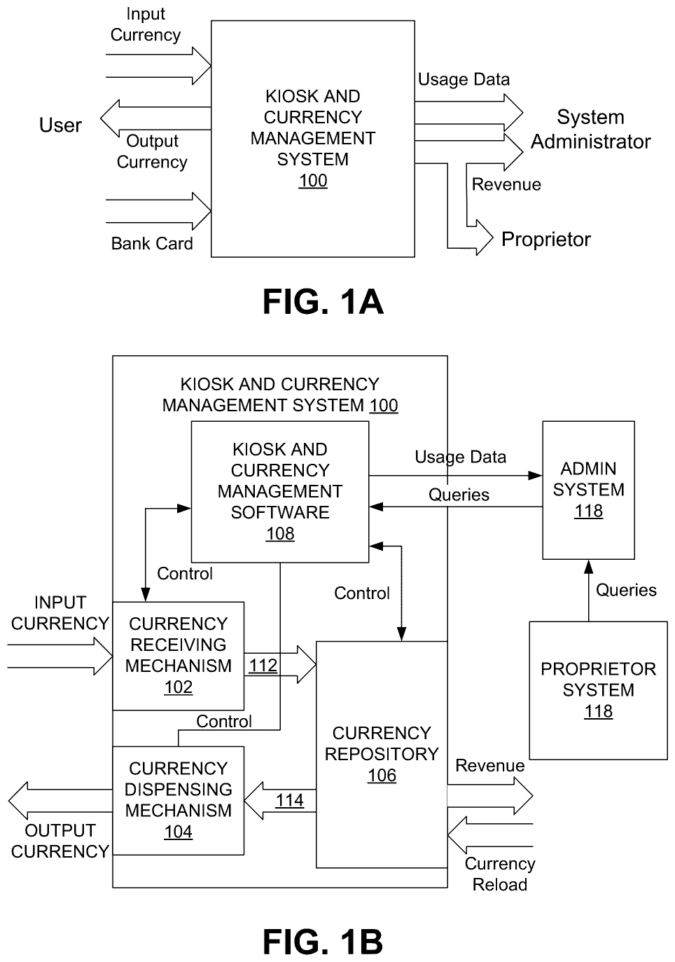

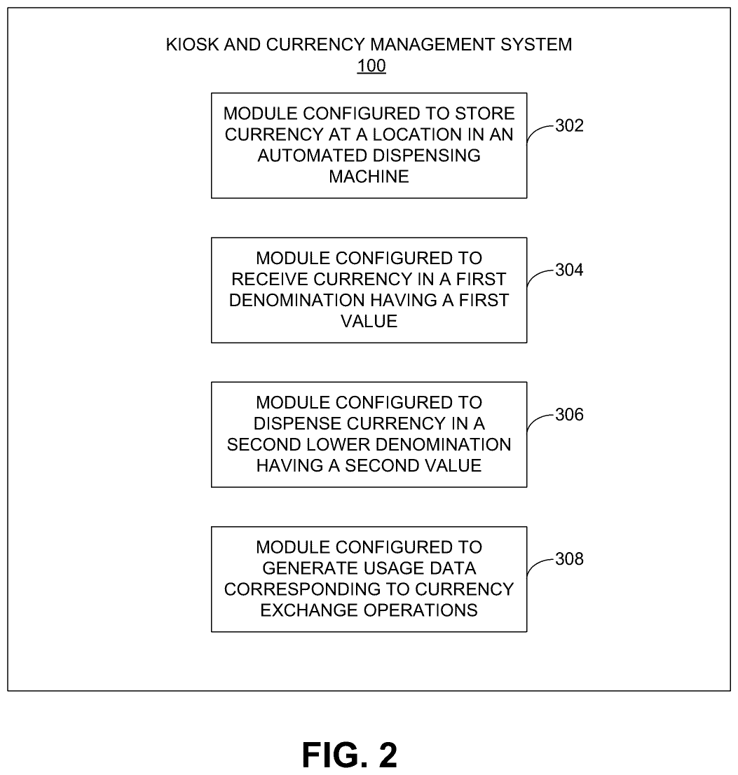

FIG. 1A is a block diagram of a kiosk and currency management system 100 showing the actors or entities involved, and various inputs of and outputs of the system 100. The system 100 is maintained by a system administrator and is placed in an establishment such as an entertainment venue that is owned by a proprietor. The proprietor allows users to use the system 100 for the purpose of exchanging input currency for output currency. Users may include customers of the establishment and workers at the establishment. Thus, in an adult entertainment venue, the actors interacting with the system 100 may include patrons and dancers in the user role, and a club manager in the proprietor role.

Bill conversion is one function supported by various embodiments of the kiosk and change management system, whereby large denomination bills may be exchanged for smaller denomination bills. These smaller denomination bills may then be used for tipping at an establishment. Examples include the conversion of $100, $50, $20 and $10 into $1 bills, also known as singles. Bill conversion may also involve the conversion from a foreign currency to U.S. bills. The operator of the kiosk and currency management system 100 may generate revenue from this bill conversion function by charging the user a fee for service. This fee may be implemented by discounting or holding back a portion of the currency provided to the user.

Some embodiments of the kiosk and currency management system 100 may also support transactions involving an automatic teller machine (ATM) card, a bank card, a credit card, a stored value card, or any other type of financial services card. Such embodiments may allow the user to withdraw funds from a financial account associated with the card and receive the funds in the form of small denomination bills such as singles. Conversely, the user may deposit currency, for example in the form of small denomination bills, into an account associated with the financial services card. These card services provided by the system 100 thus provide functionality analogous to an automated teller machine (ATM). The card services may also include foreign exchange when applicable, and in such cases the exchange rate may be subject to ATM processing regulations.

Some embodiments of the system 100 which include card services may support rollover between financial accounts. For example, if a patron or customer has exceeded his daily maximum withdrawal limit on a debit card he will be automatically be prompted to perform a point of service (POS) debit authorization in order to withdraw additional funds. The rollover functions may be linked or chained to multiple accounts. For example, if a patron has exceeded funds available from his debit card but has a credit card, he will be given information on accessing funds utilizing his credit cards via an access authorization process. The access authorization card may involve a personal identification (PIN) code, or may be PIN-less.

The operator of the kiosk and currency management system 100 may generate revenue from these functions by charging the user a fee for card services. Such fees may be assessed by surcharging the user's financial account and collected through the banking interchange or settlement process.

As noted earlier, workers in an establishment may also be users of the kiosk and change management system 100. Such workers are likely to have a need for services because the workers are receiving small-denomination bills from the patrons, sometimes in significant amounts. The currency exchange functions for workers may include accepting small-denomination bills, such as singles, through a bunch note validator, then loading the value of the input currency onto a prepaid credit card or stored value card. The system 100 may also dispense such prepaid or stored value cards. The operator of the kiosk and currency management system 100 may generate revenue from services provided to workers by charging the worker a fee for service. For example, the operator may charge the worker a fee to load the stored value card, or may collect transaction fees on such cards when the worker uses the card to make purchases.

Another function supported by some embodiments includes services for proprietors. One such service is the collection of fees from workers. For example, in an adult entertainment venue, it is typical for the proprietor to charge each dancer a “bar fee.” Some embodiments of the kiosk and currency management system 100 are operable to collect such fees from the worker, which allows the proprietor to avoid collecting fees from a dancer before she begins a work shift. The workers may pay bar fees by depositing cash into the system 100, or by using a financial services card such as a debit card, prepaid credit card, or stored value card. The amount of the bar fee may depend on factors such as time of day and day of the week. Various mechanisms may be used to identify the worker paying the fee, such as a PIN code, or a photo will be taken by the system 100 as the deposit is completed. The administrator of the kiosk and currency management system 100 may generate revenue from services provided to proprietors by charging the proprietor a per-transaction fee.

Another operation supported by some embodiments of the kiosk and currency management system 100 is fund transfer between the system 100 and a financial account associated with business establishment. This service allows a proprietor to cash into the system 100, and then the administrator electronically transfers corresponding funds to the proprietor's business checking account. This saves the proprietor time by avoiding a trip to the bank to deposit cash. The administrator may generate revenue from this service by charging the proprietor a transfer fee.

Revenue which may be generated as a result of these various uses of the system 100 may be returned to one or both of the system administrator and the proprietor.

As the system 100 operates, usage data 116 is generated, and the usage data 116 can be sent to the system administrator, who may use the data for a variety of uses. The uses of the data include maintaining the systems and determining usage trends, among others.

Reference is made to FIG. 1B, which is a block diagram illustrating an embodiment of a kiosk and currency management system 100. The system 100 includes a currency receiving mechanism 102, a currency dispensing mechanism 104, a currency repository 106, and kiosk and currency management software 108. The currency receiving mechanism 102 is configured to receive input currency 112 from a user 110 and to deliver the input currency 112 to the repository of currency 106. The kiosk and currency management software 108 is configured to determine output currency 114, which the currency dispensing mechanism 104 dispenses to the user 110. For example, the output currency can be U.S. currency in the form of bills having a denomination and value that is one of $1, $5, $10, $20, $50, and $100. The kiosk and currency management software 108 is configured to determine a value of the output currency 114, and a denomination of bills to be dispensed as output currency. The software 108 may control the operation of the currency receiving mechanism 102, currency dispensing mechanism 104, and currency repository 106, by sending various control signals and/or instructions, as should be appreciated.

In some embodiments, the denomination of each bill dispensed as output currency 114 is smaller than the denomination of the bill received as input currency 112, while the total value of the output currency 114 dispensed is less than or equal to the value of the input currency received. Alternative embodiments can include a payment receiving mechanism configured to receive payments through an electronic transfer including, but not limited to credit cards and debit cards, among others.

In the embodiment shown, the system 100 interacts with an administrator system 118 and a proprietor system 122. As the software 108 performs its various functions, usage data is generated and provided to the administrator system 118. The administrator system 118 may query the software 108 and/or run reports. The proprietor system 122 may also query the administrator system 188 and/or run reports.

The currency receiving mechanism 102 may include a bill validator. The repository of currency 106 can include, for example, a stacker or a lockable removable cassette for holding larger notes, a cassette for holding smaller notes, or both. The repository of currency 106 is intermittently refreshed by, for example, the system administrator or the proprietor. Refreshing the repository of currency 106 may include restocking the repository with relatively large quantities of currency in the denominations dispensed by the currency dispensing mechanism 104, and removing revenue 120 from the repository.

The kiosk and currency management software 108 is operable to determine the output currency 114 to be dispensed from the currency dispensing mechanism 104 based on the input currency 112 input into the currency receiving mechanism 102. More specifically, the kiosk and currency management software 108 is operable to determine a value of output currency 114 to be dispensed, and a denomination for bills to be dispensed as output currency. For example, an output currency 114 of ninety-four $1 bills has a value of $94 and a denomination of $1.

Based on the value of the input currency 112, the software 108 is operable to determine a value of the output currency 114. The software 108 may be operable to determine a value of the output currency 114 that is less than or equal to the value of the input currency 112. In some cases, the value of the output currency 114 determined by the logic 108 is less than the value of the input currency 112 regardless of the value of the input currency. In other cases, the value of the input currency 112 is used by the logic 108 to determine whether the value of the output currency 114 is the same as or lower than the value of the input currency 112. These embodiments are merely illustrative, and other embodiments of the software 108 may be operable to determine the value of the output currency 114 based on the value of the input currency 112 in a manner other than the manner described above.

Because the output currency 114 is dispensed in the form of a plurality of bills having specific denominations, the software 108 is also operable determine the denomination of bills to be dispensed as output currency 114, and for each denomination, the quantity of bills to be dispensed. In all cases, the denomination of each bill dispensed as output currency 114 is less than the denomination of the bill input as input currency 112. In some embodiments, the output currency 114 is dispensed in the form of a plurality of bills having a single denomination. In other embodiments, the output currency is dispensed using a combination of bills having varying denominations. For example, the output currency 114 may include one or more $10 bills and one or more $1 bills. In still other embodiments, the user 110 may choose the denomination of the output currency 114. In such an embodiment, the system 100 has an interface (not shown). The user 110 interacts with the interface to communicate his choice of denomination to the logic 108, which is configured to consider the choice in determining the denomination of the output currency 114. Once the logic 108 determines the value and denomination of output currency 114, bills having the value and denomination determined by the logic are dispensed from the repository of currency 106 through the currency dispensing mechanism 104 to the user 110.

The difference in value between the value of the input currency 112 provided by the user 110 and the value of output currency 114 returned to the user is revenue 120 of the kiosk and currency management system 100. The revenue 120 of the system 100 may be retained by the administrator 118 of the system 100, the proprietor 122 of the establishment, or some combination thereof. In one embodiment, the administrator 118 retains the revenue 120 until the revenue exceeds a threshold value, and shares the revenue with the proprietor 122 once the revenue exceeds the threshold. For example, the administrator 118 may retain the first $1000 in revenue 120, and may share the revenue with the proprietor 122 thereafter.

In a first embodiment, the system 100 is configured to receive bills of U.S. currency having a denomination of $50 or $100, and to dispense bills of U.S. currency having a denomination of $1 and/or $10. In such an embodiment, the currency receiving mechanism 102 accepts $50 bills and $100 bills, and rejects bills of any other denomination. For input currency 112 in the form of a $100 bill, the value of the output currency 114 determined by the logic 108 is $94 and the value of the revenue 120 retained by the system 100 is $6. The logic determines that seven bills having a $10 denomination and twenty-four bills having a $1 denomination will be dispensed as output currency 114. The currency dispensing mechanism 104 then dispenses seven $10 bills and twenty-four $1 bills from the repository of currency 106. For input currency 112 in the form of a $50 bill, the value of the output currency 114 determined by the software 108 is $45 and the value of the revenue 120 retained by the system 100 is $5. The software 108 determines that three bills having a $10 denomination and fifteen bills having a $1 denomination will be dispensed as output currency 114. The currency dispensing mechanism 104 then dispenses three $10 bills and fifteen $1 bills from the repository of currency 106.

In a second embodiment, the system 100 is configured to receive bills of U.S. currency having a denomination that is one of $5, $10, $20, $50, and $100, and to dispense bills of U.S. currency having a denomination of $1. In such an embodiment, the currency receiving mechanism 102 accepts $5 bills, $10 bills, $20 bills, $50 bills, or $100 bills, and rejects bills of any other denomination. In some embodiments, when input currency 112 is in the form of a $5 bill, the value of the output currency 114 determined by the software 108 is $5 and the value of the revenue 120 retained by the system 100 is $0. For input currency 112 in the form of a $10 bill, the value of the output currency 114 determined by the software 108 is $9 and the value of the revenue 120 retained by the system 100 is $1. For input currency 112 in the form of a $20 bill, the value of the output currency 114 determined by the software 108 is $18 and the value of the revenue 120 retained by the system 100 is $2. For input currency 112 in the form of a $50 bill, the value of the output currency 114 determined by the software 108 is $45 and the value of the revenue 120 retained by the system 100 is $5. For input currency 112 in the form of a $100 bill, the value of the output currency 114 determined by the software 108 is $94 and the value of the revenue 120 retained by the system 100 is $6.

In each case, the software 108 determines that bills having a $1 denomination should be dispensed as output currency 114. The software 108 then calculates the quantity of $1 bills to be dispensed, and the currency dispensing mechanism 104 dispenses the appropriate quantity from the repository of currency 106. Although for the embodiments discussed above, the value of output currency 114 is the same as the value of input currency 112 for a given transaction, in other embodiments, a transaction charge is assessed such that the value of output currency 114 is less than the value of input currency 112.

In a third embodiment, the system 100 is configured to receive bills of U.S. currency having a denomination of $5, $10, or $20, and to dispense bills of U.S. currency having a denomination of $1. In such an embodiment, the currency receiving mechanism 102 accepts $5 bills, $10 bills, and $20 bills, and rejects bills of any other denomination. For input currency 112 in the form of a $5 bill, the value of the output currency 114 determined by the software 108 is $5 and the value of the revenue 120 retained by the system 100 is $0. For input currency 112 in the form of a $10 bill, the value of the output currency 114 determined by the software 108 is $9 and the value of the revenue 120 retained by the system 100 is $1. For input currency 112 in the form of a $20 bill, the value of the output currency 114 determined by the software 108 is $18 and the value of the revenue 120 retained by the system 100 is $2. In each case, the software 108 determines that bills having a $1 denomination should be dispensed as output currency 114. The software 108 then calculates the quantity of $1 bills to be dispensed, and the currency dispensing mechanism 104 dispenses the appropriate quantity from the repository of currency 106.

In other embodiments, the system 100 may accept different denominations of bills than those described above, and for the denominations described, the system may dispense output currency 114 having a different value or in the form of different quantities and/or denominations of bills than described above. Such embodiments could be effectuated by altering the currency receiving mechanism 102 and/or the software 108. It will be understood that while specific scenarios for exchanging a particular amount of input currency 112 for another particular amount of output currency 114 are discussed herein, these are only examples, and other exchanges and fee structures are contemplated. Similarly, while specific mixes of input and output denominations are discussed herein, other mixes are possible.

It should be noted that the input currency 112 and output currency 114 is described above as being U.S. currency by way of example, and that in other embodiments, the input and/or output currency may be issued by a government other than the United States, or may be issued by an entity other than a government. For example, a particular establishment may choose to utilize a private currency that is only valid at that facility.

The software 108 is also operable to provide usage data 116 to the administrator 118. The usage data 116 can include any data that can be collected by the system. For example, the usage data 116 may include transaction data such as the time of an exchange, the denomination of input currency 112, the denomination of output 114 currency, the value of the output currency 114 dispensed, and the time and/or day of the transaction. The usage data 116 may also include other data such as the amount of currency available in the repository of currency 106, the frequency of use of the system 100, and the state of repair of the system 100. Such usage date 116 may be transmitted to the administrator 118 by the software 108. For example, the system 100 may include a wired or wireless communication device that is configured to transmit the usage data 116 to the administrator 118. The administrator 116 may use the usage data 116 to determine, for example, whether the repository of currency 106 needs to be replenished or whether the system 100 needs to be repaired. Additionally, the usage data may be used by the proprietor to determine periods of more or less profit.

The system 100 may be configured to perform the exchange relatively quickly. The user 110 may receive output currency 114 from the currency dispensing mechanism 114 within seconds of when the user input currency 112 into the currency receiving mechanism 102.

The various components of the system 100 may be housed within a console or kiosk. The console may be relatively secure and constructed of a physically resilient material. The console also can include a communication mechanism operable to communicate the usage data 116 from the system 100 to the administrator 118, using wired or wireless devices, or same combination thereof. An access door of the console may enable the administrator 118 or the proprietor 122 to access to an interior of the console for the purpose of removing currency from or adding currency to the repository of currency 106.

The administrator 118 may be, for example, an owner, lessor, or a provider of the system 100, and the proprietor 122 may be responsible for the establishment in which the system is placed. A variety of relationships may exist between the administrator 118 and the proprietor 122. For example, the administrator 118 may sell the system 100 to the proprietor 122, the administrator may retain ownership of the system, or the administrator may lease the system to the proprietor. A variety of financial arrangements may also exist between the administrator 118 and the proprietor 122. For example, the administrator 118 may charge the proprietor 122 a fee for the sale or lease of the system 100, the revenue of the system 100 may be given to the administrator 118 and/or proprietor, and the administrator may charge the proprietor a maintenance fee, such as a monthly fee. The maintenance fee may be in addition to or a substitute for a fee for selling or leasing the system 100, or for receiving the revenue of the system. The maintenance fee may entitle the proprietor 122 to services such as the use of the system 100, access to the usage data 116, and/or replenishment of the repository of currency 106. For example, the administrator 118 may maintain the currency stock within the repository of currency 106 by monitoring the usage data 116 to determine when the repository of currency 106 needs to be restocked, and by restocking the repository of currency 106 when needed. For example, the administrator may dispatch a secure transportation service, such as a Brinks truck, to restock the repository of currency 106. The currency within the repository of currency 106 may belong to the administrator 118 or to the proprietor 122.

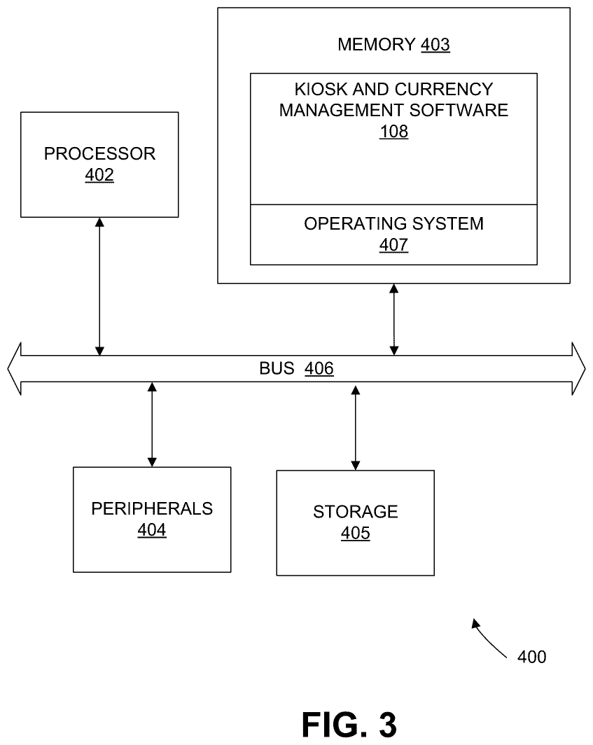

FIG. 2 is a block diagram of an embodiment of a system 300 for providing and managing currency. The system 300 includes logic 302 configured to store currency at a location in an automated dispensing machine, logic 304 configured to receive currency in a first denomination having a first value, logic 306 configured to disperse currency in a second lower denomination having a second value, and logic 308 configured to generate usage data corresponding to currency exchange operations.

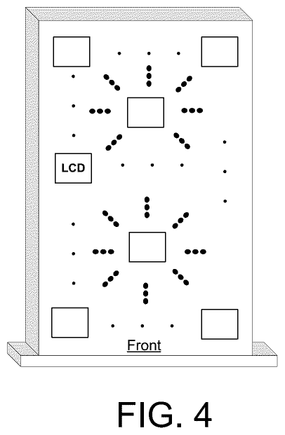

FIG. 3 is a block diagram of a computing device 400 that can be used to implement the kiosk and currency management system 100 according to various embodiments disclosed herein. The computing device contains a number of components that are familiar to a person of ordinary skill in the art, including a processor 402, memory 403, one or more peripheral devices 404, and non-volatile storage 405 (e.g., hard disk, flash RAM, flash ROM, EEPROM, etc.). The components are coupled via one or more buses 406. In an example, embodiment of computing device 400, the peripheral devices 404 include: a monitor; one or more bill acceptors such as a single note acceptor and a bunch note acceptor; a bill dispenser; a printer; a power supply; a backup power supply; a card reader; a key pad. The computing device 400 may be housed in a kiosk enclosure. Omitted from the above figure are a number of conventional components, known to those skilled in the art, which are not necessary to explain the operation of the computing device 400.

Instructions making up the kiosk and currency management software 108 are loaded into memory 403 and from there executed by the processor 402. Thus, the processor 403 is configured by these instructions to implement the kiosk and currency management software 108. Instructions making up an operating system 407 may also be loaded into memory and executed by the processor 402. While the functionality of the system 100 is described herein as being implemented by software (i.e., code executed by processor 402), in other embodiments these functions may be implemented by dedicated hardware, or by a combination of software and hardware.

In a dedicated hardware embodiment, the functionality of kiosk and currency management software 108 may instead be implemented as a circuit or state machine that employs any one of or a combination of a number of technologies. These technologies may include, but are not limited to, discrete logic, a programmable logic device, an application specific integrated circuit (ASIC), a field programmable gate array (FPGA), a system on chip (SoC), a system in package (SiP), or any other hardware device having logic gates for implementing various logic functions upon an application of one or more data signals. Such technologies are generally well known by those skilled in the art and, consequently, are not described in detail herein.

The present disclosure additionally presents improved systems and methods for dispensing currency from a kiosk. Accordingly, one such system and method is designed to make sure that a kiosk can continue dispensing cash even when a bill jam occurs. Because the kiosk is targeted for dispensing significantly more notes than a typical cash dispensing application in a target environment (e.g., dance establishment), the likelihood of a bill jam is far higher in this type of environment. For instance, a traditional ATM that has a single cassette and is loaded with $20 bills will only need to dispense 5 notes to fulfill a cash request for $100. In the target environment, $100 of value could require up to 100 notes since both an ATM application and a bill breaking application of an exemplary kiosk utilize $1 bills. This would mean that dispensers of an exemplary kiosk are doing up to 20-fold as much work to complete $100 worth of value as a traditional ATM. In addition to this system also utilizing the same dispensers to perform ATM and change to change (“bill break”) transactions which means more transactions per day and significantly more notes being dispensed, an improved system and method is designed to resolve bill breaking patron related issues quickly and accurately in order to reconcile outstanding monies on-site. In various embodiments, this is done by generating a detailed receipt at the kiosk, texting this report to the staff, and simultaneously emailing it to a business's management each time a bill jam occurs. This receipt/report is simultaneously sent out to all parties and shows the exact amount of money that was inserted into the acceptor and the amount that is currently owed to the patron. This allows management with the information needed to cash out the patron immediately in the event that a bill jam occurs while using the bill break function. When presented with the printed report, management takes money from a float amount of currency that is left at the establishment to pay the patron. In this way, the patron is made whole within minutes and no phone call is needed at late hours to resolve this issue. The kiosk user interface can then indicate that the bill break function is no longer available (e.g., bill breaking icon turns grey), but the ATM function continues to dispense $20 bills for the remainder of the night (e.g., the ATM icon remains intact and will continue to dispense $20 bills from the top cassette). The end of day reports will indicate how much of the cash in the machine needs to be given back to the float that is kept at the location. No fees are discounted for this type of transaction. Bill jams that occur from ATM related transactions do not require these steps because the ATM network automatically credits the patron's account if the amount authorized exceeds the amount that was dispensed in the event of a partial dispense.

For bill break requests, an exemplary kiosk system can receive and accept cash from a user and provide $1 bills in change on demand. In various embodiments, a service fee is discounted from the amount deposited by the user, such that a patron user does not have to wait on staff to provide change to the patron.

Various solutions of the present disclosure address the frequent bill jam issues that surround dispensing one dollar bills through a cash dispensing system. This update addresses a problem that is unique to dispensing $1 bills. Specifically, $1 bill dispensing involves the use of a very large number of bills and a very low quality of bills. These two factors contribute to the high bill jam ratio that we have found a way to manage by offering an immediate resolution to an issue that we know can happen late at night without the need to speak to anyone at a particular business's office.

In various embodiments, an exemplary system and method of the present disclosure can dispense a plurality of denomination of bills, while the primary or default dispensing denomination is $1 bills, which is unique amongst cash dispensing systems. In fact, for conventional cash dispensing systems, a request for a mix of different denomination of currency was addressed in one of two ways. A first option is used to satisfy or process a request by using as few notes as possible (opposite of what a business's target market may demand). For instance if $43 dollars was requested, then a conventional system would dispense 2×$20 bills plus 3×$1 bills from two separate cassettes. A second scenario involves one in which the system allows a user to choose how many of each denomination is returned but specifically limits the amount of singles involved. In this scenario, the largest amount of singles that may be dispensed is far less than that which would be demanded in a prospective target market (that is in need of $1 bills). Thus, an exemplary system and method of the present disclosure solves this problem and allows the patron to receive as many singles ($1 bills) as the kiosk hardware allows and a business's customers may demand. In various embodiments, an exemplary system and method are configured to dispense $1 bills as a default denomination, where additional denominations may be provided upon request by a user and/or as needed to fulfill a cash request.

In various embodiments, an exemplary kiosk system also features a sidecar option for providing bill break services. For example, instead of receiving $1 bill dispensed from a cash dispensing mechanism of the kiosk for large or bulk currency amounts (e.g., $100 and above), a series of locker storage units may be provided next to or in proximity of the kiosk such that an individual storage unit is preloaded with a designated amount of $1 bills (e.g., 100 $1 bills, 200 $1 bills, 500 $1 bills, etc.), so that a locker storage unit can be opened upon receipt of the corresponding amount of currency by the kiosk or the kiosk can present a patron a code for unlocking a particular one of the locker storage units that holds the corresponding amount of currency in $1 bills that was deposited by the patron. Such a mode of operation can significantly increase the capacity of $1 bill change that can be held at a facility for both ATM and bill breaking; can significantly decrease the amount of working capital that a facility needs to have on hand to continue meeting the change-related needs of patrons wishing to tip entertainers; and can significantly decrease the rate of bill jams associated with dispensing $1 bills.

For bulk transactions involving stacks of bills that exceed 100 notes, in various embodiments, various transaction networks may be utilized as alternatives to an ATM network. For example, certain regions may have regulatory restrictions related to processing ATM transactions when bills are not processed through a cash dispenser. Accordingly, in such regions, a card based transaction may be performed, such as those involving a point-of-sale debit or cash advance credit network.

In various embodiments, different pricing models may be implemented for regular transactions (not using the sidecar locker storage implementation) versus bulk transactions (using the sidecar locker storage implementation) The pricing model for regular transactions is a surcharge fee model. Meaning, a business may charge either a flat fee or a % fee based on the amount that is requested. However, sidecar transactions may use a discount fee model. Specifically, a particular business may discount the fees from the amount deposited into the acceptor of the kiosk. Accordingly, a kiosk display interface can provide pricing for bulk cash based on a discount fee model (fast cash options will reflect prearranged discounted fees) for amounts over $100. For amounts under this amount there will be no changes and money will be dispensed using the cash dispenser. Thus, in various embodiments, a minimal value will likely equal $100 less and agreed amount of fees in each compartment.

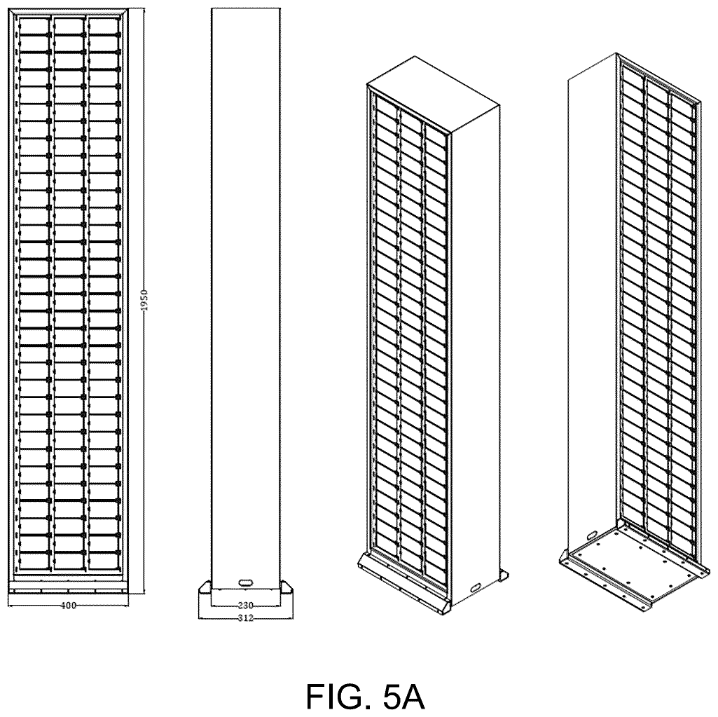

For instance, in a non-limiting example, a $500 authorization may require a service fee to be discounted (could be flat or a percentage) and the remaining amount will be made available at a specific locker location. The amount in the locker would be $500 less an agreed to fee. Similarly for $400, $300, $200, and $100 authorizations, we would do the same. The maximum amount would be equal to $1,000. For instance, if a value of $200 needs to be deposited into the acceptor, the patron could deposit two $100 bills or 4×$50 bills and inform the system that he/she is finished depositing and wishes to now get change. FIG. 4 shows an exemplary sidecar locker storage system for one non-limiting embodiment. In particular, FIG. 4 shows a perspective view. In various embodiments, the sidecar locker storage system can provide storage units on one face (e.g., front side), such that the sidecar locker storage system could be positioned against a wall, or can provide storage units on both faces (e.g., front and back sides) of the sidecar locker storage system, such that the sidecar storage locker system can be accessed via either the front or back faces. In various implementations, different numbers of locker locations or spaces can be provided (as demonstrated by the ellipses shown in the figure), along with different sizes of locker locations or spaces. In one such embodiment, 10 rows×12 columns of storage units (=120 bins) are provided on both the front and back sides of the sidecar locker storage system. In addition, a LCD locker (“LCD”) having an external scanner/screen for viewing by a patron and having a computer (e.g., similar to FIG. 3) stored within the locker space (e.g., 13 inches×13⅛ inches) that is connected to the external scanner/screen is provided in various embodiments. In various embodiments, the LCD locker display can be communicatively coupled to a kiosk unit, and in alternative embodiments, the LCD locker display can be separate from the kiosk unit such that the LCD locker display is configured to carry out cash transactions with users. In one embodiment, among others, the LCD locker display may be positioned at a height of 45 to 50 inches from the floor.

Therefore, alternative embodiments of the sidecar locker storage system are contemplated in accordance with the present disclosure. One such system provides locker storage units of varying sizes, such as a series of small lockers (e.g., 13 inches×6⅜ inches) and large lockers (e.g., 13 inches×11⅜ inches) in addition to a LCD locker having an external scanner/screen for viewing by a patron and having a computer stored within the locker space (e.g., 13 inches×13⅛ inches) that is connected to the external scanner/screen.

In another alternative embodiment, a design of the sidecar locker storage system holds between 45 and 90 compartments per system unit, with a various number of system units able to be installed at a business establishment next to a kiosk unit to drive transactions or separately from a kiosk unit with the LCD locker display driving transactions. Accordingly, the sidecar locker may operate as a separate unit altogether. This provides the ability to provide a solution to locations that already have a traditional ATM function and only require an exemplary bulk bill breaking solution. For an illustrative and non-limiting example, conventional ATM dispensers that can typically hold up to 2500 notes per cassette and use 3 such cassettes in one kiosk which provides a capacity of up to 7500 notes or dollars. Whereas, an exemplary sidecar arrangement of the present disclosure can provide a capacity equal to 300 notes×90 spaces or 27,000 notes per cabinet. Thus one such cabinet/sidecar can increase the capacity of $1 bills at a facility by almost 360% not to mention that they are being designed to be able to fit multiple units at a location (small foot print).

The disclosed improvements for automated change related tasks enable the staff at facilities to focus on their other duties instead of making change and reduces the working capital requirements for locations and risks associated with manual change making, while creating a new profit share opportunity for facility.

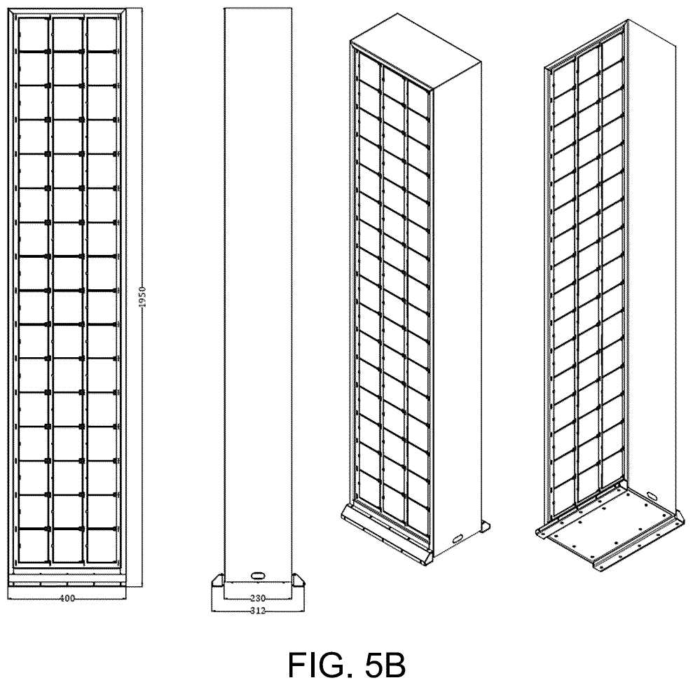

As discussed above, an exemplary sidecar assembly can have a variety of sized locker storage units and can have a variety of different numbers of sized locker storage units within the sidecar assembly. As illustrative and non-limiting examples, FIGS. 5A-5B shows varying views of a tower storage locker assembly have 3×32 storage units and 3×16 storage units, respectively. Accordingly, various embodiments can have more or less rows and columns of locker units, may have differently sized units, and may also be equipped with the LCD locker interface and/or an acceptor component (e.g., in place of individual storage units) that is communicatively coupled with one or more of the storage unit assemblies.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

It is also to be understood that the terminology used herein is for purposes of describing particular embodiments only, and is not intended to be limiting. It is also possible in the present disclosure that steps can be executed in different sequence where this is logically possible.

It must be noted that, as used in the specification, the singular forms “a,” “an,” and “the” include plural referents unless the context clearly dictates otherwise. Unless defined otherwise, all technical and scientific terms used herein have the same meanings as commonly understood by one of skill in the art to which the disclosed invention belongs. Those skilled in the art will recognize, or be able to ascertain using no more than routine experimentation, many equivalents to the specific embodiments of the present disclosure described herein.

Any logic or application described herein that comprises software or code can be embodied in any non-transitory computer-readable medium for use by or in connection with an instruction execution system such as, for example, the processor 402. In this sense, the logic may comprise, for example, statements including instructions and declarations that can be fetched from the computer-readable medium and executed by the processor 402. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure.

1. A method for currency management comprising:
providing an automated kiosk at a business locale;
providing a sidecar locker storage assembly that is communicatively coupled to the automated kiosk at the business locale, wherein the sidecar locker storage assembly comprises a plurality of storage units having individual locks;
receiving, at the automated kiosk, cash currency in one or more denominations having a first value from a first user, wherein the first value is greater than a second value, and the one or more denominations are greater than a second denomination;
individually dispensing, by the automated kiosk, cash currency in the second denomination having the second value; and
bulk dispensing, by the sidecar locker storage assembly, cash currency in the second denomination by unlocking one of the storage units, wherein the opened storage unit contains a bulk amount of cash currency in the second denomination at a third value, wherein a total value of the second value and the third value is equal to or less than the first value.

2. The method of claim 1, wherein the second denomination is a single dollar bill or bank note.

3. The method of claim 1, further comprising:
withholding a fee to be credited to a proprietor of the business locale, wherein a value of the fee is equal to the first value minus the total value of the second value and the third value.

4. The method of claim 3, further comprising electronically transferring a monetary value of the fee, by the automated kiosk, to a financial account of the proprietor.

5. The method of claim 3, wherein the fee is generated when a total sum of cash currency received by the automated kiosk surpasses a predefined threshold value.

6. The method of claim 1, wherein the cash currency in the one or more denominations is foreign currency with respect to the cash currency in the second denomination.

7. The method of claim 1, further comprising:
receiving, at the automated kiosk, an ATM or bank card of a second user;
withdrawing, at the automated kiosk, an amount of currency having a fourth value from a financial account of the second user associated with the ATM or bank card, wherein the fourth value is greater than the second value;
individually dispensing, by the automated kiosk, cash currency in the second denomination having the second value to the second user; and
bulk dispensing, by the sidecar locker storage assembly, cash currency in the second denomination by opening one of the storage units to the second user, wherein the opened storage unit contains a bulk amount of cash currency in the second denomination at a fifth value, wherein a total value of the second value and the fifth value is equal to or less than the fourth value.

8. The method of claim 1, further comprising:
receiving, at the automated kiosk, cash currency in the second denomination having a third value from a second user; and
electronically transferring a monetary value corresponding to the received cash currency to a financial account of the second user.

9. The method of claim 1, further comprising loading at least 300 notes of currency in each storage unit of the sidecar locker storage assembly before placing the sidecar locker storage assembly in operation.

10. The method of claim 1, wherein the plurality of storage units are of different sizes, wherein the plurality of storage units are located on both faces of the sidecar locker storage assembly.

11. An automated kiosk system for currency management comprising:
a currency receiving mechanism to receive cash currency in one or more denominations having a first value from a first user, wherein the first value is greater than a second value, and the one or more denominations are greater than a second denomination;
a currency dispensing mechanism to individually dispense cash currency in the second denomination having the second value;
a processor communicatively coupled to the currency receiving mechanism and the currency dispensing mechanism, wherein the processor is configured to control receiving and dispensing of cash currency;
a sidecar locker storage assembly that is communicatively coupled to the processor, wherein the sidecar locker storage assembly comprises a plurality of storage units having individual locks,
wherein the processor is further configured to control bulk dispensing, by the sidecar locker storage assembly, cash currency in the second denomination by unlocking one of the storage units, wherein the opened storage unit contains a bulk amount of cash currency in the second denomination at a third value, wherein a total value of the second value and the third value is equal to or less than the first value.

12. The automated kiosk system of claim 11, wherein the second denomination is a single dollar bill or bank note.

13. The automated kiosk system of claim 11, wherein the processor is further configured to withhold a fee to be credited to a proprietor of a business locale where the automated kiosk is located, wherein a value of the fee is equal to the first value minus the total value of the second value and the third value.

14. The automated kiosk system of claim 13, wherein the processor is further configured to electronically transfer a monetary value of the fee, by the automated kiosk, to a financial account of the proprietor.

15. The automated kiosk system of claim 13, wherein the fee is generated when a total sum of cash currency received by the automated kiosk surpasses a predefined threshold value.

16. The automated kiosk system of claim 11, wherein the cash currency in the one or more denominations is foreign currency with respect to the cash currency in the second denomination.

17. The automated kiosk system of claim 11, wherein the processor is further configured to cause the automated kiosk system to:
receive, at the automated kiosk, an ATM or bank card of a second user;
withdraw, at the automated kiosk, an amount of currency having a fourth value from a financial account of the second user associated with the ATM or bank card, wherein the fourth value is greater than the second value;
individually dispense, by the automated kiosk, cash currency in the second denomination having the second value to the second user; and
bulk dispense, by the sidecar locker storage assembly, cash currency in the second denomination by opening one of the storage units to the second user, wherein the opened storage unit contains a bulk amount of cash currency in the second denomination at a fifth value, wherein a total value of the second value and the fifth value is equal to or less than the fourth value.

18. The automated kiosk system of claim 11, wherein the processor is further configured to cause the automated kiosk system to:
receive, at the automated kiosk, cash currency in the second denomination having a third value from a second user; and
electronically transfer a monetary value corresponding to the received cash currency to a financial account of the second user.

19. The automated kiosk system of claim 11, wherein the plurality of storage units are of different sizes, wherein the plurality of storage units are located on both faces of the sidecar locker storage assembly.

20. The automated kiosk system of claim 11, wherein each storage unit is capable of holding at least 300 notes of currency.
